(19) United States
(12) Patent Application Publication
(10) Pub. No.: US 2025/0376960 A1
(43) Pub. Date: Dec. 11, 2025

(54) FUEL INJECTION CONTROL DEVICE

(71) Applicant: TOYOTA JIDOSHA KABUSHIKI KAISHA, Toyota-shi (JP)

(72) Inventors: Rihito KANEKO, Miyoshi-shi (JP); Akihiko HIGUCHI, Nagoyo-shi (JP); Shohei HAMADA, Nagoya-shi (JP); Shin OKADA, Toyota-shi (JP); Kotaro SUZUKI, Kariya-shi (JP); Masanao IDOGAWA, Nagoya-shi (JP); Takahiro UCHIDA, Okazaki-shi (JP); Hirokazu ANDOH, Seto-shi (JP); Yuya NISHIKAWA, Nagoya-shi (JP); Motohiro SUGIMOTO, Toyota-shi (JP); Eiichiroh KIDO, Okazaki-shi (JP); Masanori MATSUBARA, Toyota-shi (JP); Yuki YABUSHITA, Nagoya-shi (JP)

(73) Assignee: TOYOTA JIDOSHA KABUSHIKI KAISHA, Toyota-shi (JP)

(21) Appl. No.: 19/058,370

(22) Filed: Feb. 20, 2025

(30) Foreign Application Priority Data
Jun. 5, 2024 (JP) 2024-091519

(51) Int. Cl. F02D 41/26; F02D 41/14; F02D 41/40

(52) U.S. Cl. CPC F02D 41/26; F02D 41/1401; F02D 41/40; F02D 2200/0614

(57) ABSTRACT

An injection amount after λ correction corresponding to a command value of the fuel injection amount is calculated by applying correction for compensating a deviation between the request value and an amount of fuel actually burned to an injection amount before λ correction, which is a request value of an amount of fuel to be burned. In PL multi-injection control for performing the split injection, when it is determined whether or not the discrepancy of the injection amount before and after the λ correction is in a small state, the injection pattern of the split injection is decided based on the injection amount before the λ correction, and when it is determined that the discrepancy is not in a small state, the injection pattern of the split injection is decided based on the injection amount after the λ correction.

### CROSS-REFERENCE TO RELATED APPLICATION

This application claims priority to Japanese Patent Application No. 2024-091519 filed on Jun. 5, 2024, incorporated herein by reference in its entirety.

### BACKGROUND

### 1. Technical Field

The present disclosure relates to a fuel injection control device that controls fuel injection of an internal combustion engine.

### 2. Description of Related Art

An electromagnetic injector that is provided in an internal combustion engine, such as an in-vehicle engine, is provided with a valve element that opens in response to application of electricity to an electromagnetic solenoid incorporated therein. Such an injector is configured to be capable of adjusting an injection amount by changing the amount of time of applying electricity to the electromagnetic solenoid. The valve element of the injector performs a bouncing motion immediately after reaching a fully opened position, due to repercussion from an impact when reaching the fully opened position. Such bouncing motion of the valve element causes variance in the injection amount. Conversely, when the injection is completed before the valve element reaches the fully opened position, the fuel injection can be performed without being affected by the bouncing motion of the valve element.

Accordingly, partial lift injection technology such as described in Japanese Unexamined Patent Application Publication No. 2016-223443 (JP 2016-223443 A) has been conventionally proposed as technology for realizing high-precision small-volume injection. Partial lift injection is fuel injection in which an amount of time of applying electricity is set to be a shorter amount of time than the amount of time that is necessary for the valve element to reach a fully opened position. On the other hand, fuel injection in which the amount of time of applying electricity is set to be a longer amount of time than the amount of time necessary for the valve element to reach the fully opened position is called full lift injection. Note that JP 2016-223443 A also describes a requested amount of fuel being split into a plurality of injections including partial lift injection and full lift injection, and being supplied to an internal combustion engine.

### SUMMARY

When an injection pattern, such as the count of times of splitting the injection in split injection that is described above, the injection method of each injection, and so forth, is changed as described above, exhaust characteristics, combustion efficiency, and so forth, of the internal combustion engine change. Accordingly, there is demand for an accurate method for switching injection patterns of split injection, in accordance with operating conditions of the internal combustion engine.

A fuel injection control device that solves the above problem is a fuel injection control device that performs split injection control, the fuel injection control device performing,
in the split injection control,
computing a request value for amount of fuel to be combusted in a combustion chamber, deciding a command value for a fuel injection amount by applying a correction, for compensating for a deviation between the amount of fuel that is actually combusted and the request value, to the request value,
determining whether discrepancy between the request value and the command value is in a small state, and
deciding an injection pattern of split injection based on the request value when determining that the discrepancy is in a small state, while deciding the injection pattern based on the command value when determining that the discrepancy is not in a small state.

The fuel injection control device has an effect of enabling setting of the appropriate injection pattern according to the operation state of the internal combustion engine.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating a configuration of an embodiment of a fuel injection control device;

FIG. 2 is a flow chart of a PL multi-injection control routine executed by the fuel injection control device of FIG. 1; and

FIG. 3 is a diagram schematically illustrating a setting mode of a selection table of a candidate list of injection patterns.

### DETAILED DESCRIPTION OF EMBODIMENTS

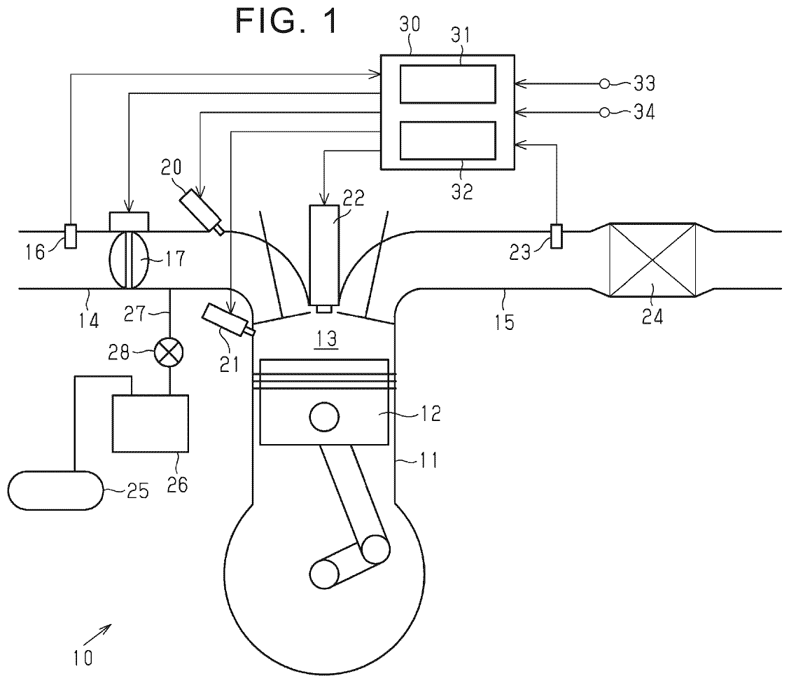

Hereinafter, an embodiment of a fuel injection control device will be described in detail with reference to FIGS. 1 to 3.

### Configuration of Fuel Injection Control Device

First, the configuration of the fuel injection control device of the present embodiment will be described with reference to FIG. 1. The fuel injection control device of the present embodiment is applied to a multi-cylinder internal combustion engine 10.

The internal combustion engine 10 includes a plurality of cylinders 11. In FIG. 1, only one of the plurality of cylinders 11 is displayed. Pistons 12 are arranged in each cylinder 11 so as to be able to reciprocate. In each cylinder 11, a combustion chamber 13 for combustion of fuel is partitioned and formed by a piston 12.

The internal combustion engine 10 includes an intake passage 14 through which intake air introduced into the combustion chamber 13 flows, and an exhaust passage 15 through which exhaust gas generated by combustion in the combustion chamber 13 flows. An air flow meter 16 for detecting an intake air flow rate GA and a throttle valve 17, which is a valve for adjusting an intake air flow rate GA, are installed in the intake passage 14. An intake manifold 18, which is a branch pipe for distributing intake air to each combustion chamber 13, is installed in a portion of the intake passage 14 on the downstream side of the throttle valve 17. The intake passage 14 is connected to the combustion chambers 13 of the respective cylinders 11 through the intake ports 19 of the respective cylinders after branching off in the intake manifold 18. A port injection injector 20 is installed in the intake port 19 of each cylinder 11, and an in-cylinder injection injector 21 is installed in the combustion chamber 13 of each cylinder 11. Further, an ignition device 22 that starts combustion by spark discharge is installed in the combustion chamber 13 of each cylinder 11. An air-fuel ratio sensor 23 for detecting an air-fuel ratio of the air-fuel mixture burned in the combustion chamber 13 and a catalyst device 24 for exhaust gas purification are installed in the exhaust passage 15.

Further, the internal combustion engine 10 includes a fuel vapor processing device. The fuel vapor processing apparatus includes a canister 26 containing an adsorbent for collecting fuel vapor generated in the fuel tank 25. Further, the fuel vapor processing apparatus includes a purge passage 27 that connects the canister 26 and the intake manifold 18, and a purge valve 28 that opens and closes the purge passage 27. The canister 26 adsorbs and stores the fuel vapor generated in the fuel tank 25 by the adsorbent. The fuel vapor stored in the canister 26 is purged into the intake air by opening the purge valve 28 while a negative pressure is generated in the intake manifold 18. The fuel vapor processing apparatus processes the fuel vapor by purging a purge gas containing the fuel vapor generated in the fuel tank 25 into the intake air and burning the purge gas in the combustion chamber 13.

The internal combustion engine 10 is controlled by an engine control module (ECM) 30. ECM 30 includes a storage device 31 in which a program and data for controlling the internal combustion engine are stored, and an arithmetic processor 32 that reads and executes the program from the storage device 31. Various sensors for detecting the operating condition of the internal combustion engine 10 are connected to ECM 30. The sensors connected to ECM 30 include a water temperature sensor 33 and a crank angle sensor 34 in addition to the air flow meter 16 and the air-fuel ratio sensor 23 described above. The water temperature sensor 33 is a sensor that detects the coolant temperature THW of the internal combustion engine 10. The crank angle sensor 34 is a sensor that detects a crank angle of the internal combustion engine 10. ECM 30 calculates the rotational speed NE of the internal combustion engine 10 based on the detected value of the crank angle sensor 34. ECM 30 calculates the operating amounts of the internal combustion engine 10, such as the throttle opening, the ignition timing, and the injection amount, based on the detected values of the sensors. ECM 30 controls the throttle valve 17, the ignition device 22, the injectors 20 and 21, and the like based on the calculation result of the manipulated variable, thereby controlling the operating state of the internal combustion engine 10. In the present embodiment, as part of the control of the internal combustion engine 10, an ECM 30 for controlling the fuel injection of the injectors 20 and 21 corresponds to the fuel injection control device.

### Calculation of Injection Amount

ECM 30 calculates the injection amounts of the injectors 20 and 21 in the fuel injection control. When calculating the injection amount, ECM 30 first calculates, based on the loading factor KL or the like of the internal combustion engine 10, the amount of fuel whose air-fuel ratio of the air-fuel mixture burned in the combustion chamber 13 becomes the target air-fuel ratio, which is the target value, as the value of the basic injection amount QBSE. The loading factor KL represents the fill factor of the intake air of the cylinder 11. ECM 30 obtains the loading factor KL based on the intake air flow rate GA, the rotational speed NE, the opening degree of the throttle valve 17, and the like. Then, ECM 30 performs various corrections on the basic injection amount QBSE to decide the final injection amount QFIN. The final injection amount QFIN at the time of the split injection corresponds to the total amount of the respective split injections. In the correction of the injection amount at this time, there are a case where the amount of fuel actually burned in the combustion chamber 13 is changed or a case where the amount is not changed. Examples of the latter correction are correction by the air-fuel ratio feedback correction value, correction by the air-fuel ratio learned value, and correction by the purge learning reflected value.

ECM 30 performs the air-fuel ratio feedback control as part of the fuel injection control. In the air-fuel ratio feedback control, ECM 30 performs feedback correction of the injection amount so that the detected value of the air-fuel ratio by the air-fuel ratio sensor 23 approaches the target air-fuel ratio. As a result, ECM 30 compensates for the deviation of the injection amounts due to variations in the injection properties of the injectors 20 and 21 due to individual differences or temporal changes. The air-fuel ratio feedback correction value and the air-fuel ratio learned value are correction values used for correcting the injection amount in the air-fuel ratio feedback control. More specifically, in the air-fuel ratio feedback control, ECM 30 adjusts the value of the air-fuel ratio feedback correction value so that the deviation is reduced based on the deviation between the detected value of the air-fuel ratio and the target air-fuel ratio. Further, ECM 30 performs air-fuel ratio learning control for learning a steady deviation between the detected value of the air-fuel ratio and the target air-fuel ratio as an air-fuel ratio learned value. The air-fuel ratio learning control is performed by gradually replacing the value of the air-fuel ratio feedback correction value with the value of the air-fuel ratio learned value. In the present embodiment, ECM 30 learns the individual air-fuel ratio learned values for each of the port-injection and the in-cylinder injection.

In addition, ECM 30 performs correction using the purge learning reflected value as correction of the injection amount for compensating for the effect of the purge of the fuel vapor in the fuel vapor processing device. Specifically, ECM 30 estimates the fuel concentration of the fuel vapor on the basis of the change in the detected value of the air-fuel ratio when the fuel vapor processor changes the purge amount which is the flow rate of the fuel vapor during the intake, and learns the value as the vapor concentration learned value. Then, ECM 30 calculates, from the vapor density learned value and the purge amount, the amount of fuel introduced into the combustion chamber 13 through the purge of the fuel vapor as the value of the purge learning reflected value. ECM 30 performs reduction correction of the injection amount by the purge learning reflected value calculated in this way, thereby suppressing the effect of the purge of the fuel vapor on the air-fuel ratio feedback control.

As described above, the correction by the air-fuel ratio feedback correction value, the correction by the air-fuel ratio learned value, and the correction by the purge learning reflected value are the correction of the injection amount that does not change the amount of the fuel actually burned in the combustion chamber 13. In the following description, these three corrections are collectively referred to as λ correction. In the following description, although the correction other than the λ correction is reflected, the injection amount that does not reflect the λ correction is described as the injection amount before the λ correction, and the injection amount that reflects all the corrections including the λ correction is described as the injection amount after the λ correction. In the present embodiment, the final injection amount QFIN is an injection amount after correction of λ. The injection amount before λ correction corresponds to the amount of fuel actually to be burned in the combustion chamber 13, that is, the requested value of the amount of fuel to be burned in the combustion chamber 13. On the other hand, the injection amount after λ correction corresponds to the amount of fuel that instructs the injectors 20 and 21 to inject, that is, the command value of the fuel injection amount of the injectors 20 and 21.

### PL Multi-Injection Control

The in-cylinder injection injector 21 installed in the internal combustion engine 10 is configured to be capable of performing partial lift injection. The partial lift injection is a fuel injection performed without opening the needle valve of the injector 21 until full opening. The injector 21 can inject a small amount of fuel with high accuracy by performing vertical lift injection. On the other hand, the fuel injection performed by opening the needle valve of the injector 21 to the full opening is called a full lift injection. The technical details of the partial lift injection and the full lift injection are described, for example, in JP 2016-223443 A. In this specification, the partial lift may be abbreviated as “PL”, and the full lift may be abbreviated as “FL”.

During the cold operation of the internal combustion engine 10, the temperature of the bore wall surface and the piston top surface constituting the wall surface of the combustion chamber 13 is low. Therefore, during the cold operation, the amount of fuel adhering to the bore wall surface and the piston top surface without being vaporized after injection from the injector 21 increases. Here, the bore wall surface represents the wall surface of the cylinder 11, and the piston top surface represents the top surface of the piston 12. Further, in the following description, the amount of fuel adhering to the bore wall surface or the piston top surface is referred to as the wall surface adhesion amount of fuel. Since the fuel adhering to the wall surface as a liquid is less likely to burn than the vaporized fuel, it is a factor that increases the particulate matter in the exhaust gas. The wall adhesion of the fuel during the cold operation can be suppressed by dividing the required amount of the fuel into a plurality of times and injecting the fuel in small amounts. ECM 30 carries out PL multi-injection control aiming at suppressing the adherence of fuel to the wall surface during the cold operation by the split injection. PL multi-injection control is an injection control aimed at suppressing the adhesion of the wall surface of the fuel by increasing the number of divisions of the fuel injection by utilizing a partial lift injection capable of injecting a small amount of fuel.

PL multi-injection control is a kind of split injection control in which fuel to be combusted in the combustion chamber 13 is injected into the injectors 20 and 21 in a plurality of times. Specifically, the split injection control in which the injection pattern including PL injection is present in the injection pattern performed by the control is PL multi-injection control.

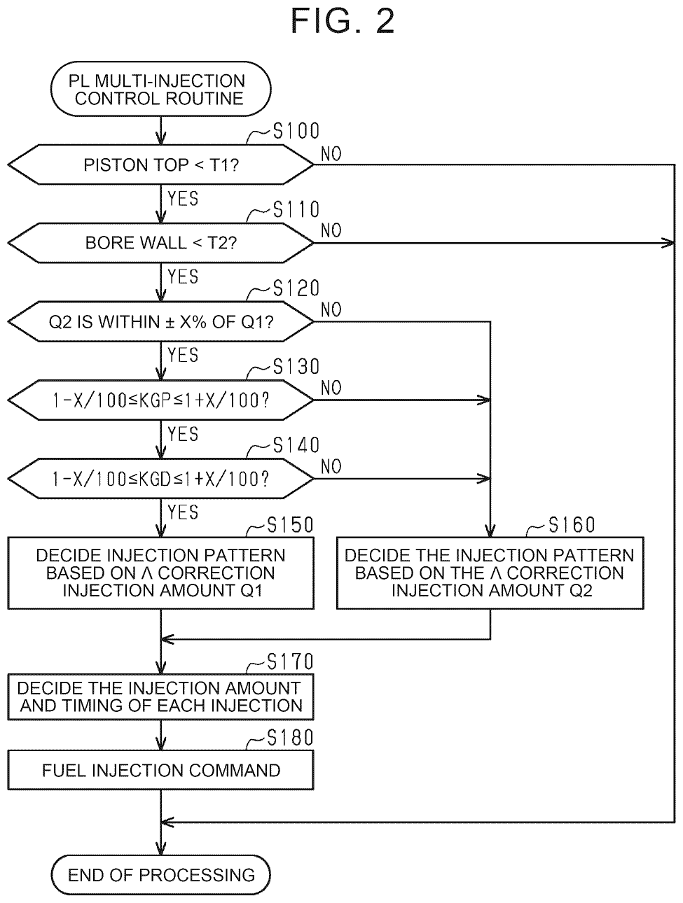

FIG. 2 shows a flow chart of a PL multi-injection control routine executed by ECM 30 for PL multi-injection control. During the operation of the internal combustion engine 10, ECM 30 repeatedly executes the process of this routine every predetermined control cycle.

When this routine is started, ECM 30 first determines whether or not PL multi-injection control is executed in S100 and S110. In the present embodiment, the following conditions are set as conditions for executing PL multi-injection control. That is, it is set as a condition that a logical product (AND) of that the piston-top surface temperature is less than the predetermined determination value T1 (S100: YES) and that the bore-wall temperature is less than the predetermined determination value T2 (S110: YES) is satisfied. The piston top surface temperature represents the temperature of the top surface of the piston 12, and the bore wall temperature represents the temperature of the wall surface of the cylinder 11. ECM 30 is obtained by estimating the piston top surface temperature and the bore wall temperature, respectively, from the coolant temperature THW, the accumulated intake air amount after the start of the internal combustion engine 10, and the like. The fulfilment of these PL multi-injection controls indicates that at least one of the piston top surface temperature and the bore wall temperature is at a certain low temperature at which particulate matter emissions may exceed acceptable limits due to fuel-wall deposition. When it is determined that the execution-condition is not satisfied (S100: NO or S110: NO), ECM 30 ends the processing of this routine in the current control cycle as it is. On the other hand, when ECM 30 determines that the execution-condition is satisfied (S100: YES, and S110: YES), the process proceeds to S120.

ECM 30 when the process is advanced to S120 determines whether or not the variation of the injection amount is small. The variation in the injection amount here refers to the variation in the command value of the fuel injection amount for each individual of the internal combustion engine 10 caused by the individual difference in the injection characteristics of the injectors 20 and 21 and the change with time.

Specifically, ECM 30 determines that the variation in the injection amount is small when both of the conditions (A) and (B) below are satisfied. The condition (A) is that the injection amount Q2 after the λ correction is within ±X % of the injection amount Q1 before the λ correction (S120: YES). The condition (B) is that the values of the air-fuel ratio learned value KGP for the port-injection and the air-fuel ratio learned value KGD for the in-cylinder injection are both within ±X % (S130: YES). Here, “X” is a constant that takes a positive value.

As described above, the injection amount Q1 before the λ correction indicates a request value of amount of the fuel to be combusted in the combustion chamber 13. The λ correction injection amount Q2 indicates a command value of the fuel injection amount of the injectors 20 and 21. Therefore, the establishment of the condition (A) means that the discrepancy between the request value and the command value is small.

Note that the injection amount after λ correction in the case of dividing the injection between the port injection and the in-cylinder injection is calculated as an amount obtained by summing the injection amount of the port injection reflecting the air-fuel ratio learned value for the port injection and the injection amount of the in-cylinder injection reflecting the air-fuel ratio learned value for the in-cylinder injection. However, since the injection pattern is not determined at the time of this determination, the injection amounts of the port injection and the in-cylinder injection are also undetermined. Therefore, since the injection amount after λ correction is not strictly obtained at the time of the determination, the success or failure of the above condition (A) cannot be strictly determined.

On the other hand, ECM 30 determines the success or failure of the condition (A) in the following manner. First, ECM 30 obtains the smallest value and the largest value of the injection amounts after the λ corrections when the injection rate of the port injection and the in-cylinder injection is changed from 100% of the port injection to 100% of the in-cylinder injection. Specifically, ECM 30 obtains the injection amount reflecting the smaller value among the two air-fuel ratio learned values as the smallest value of the injection amount after λ correction. In addition, ECM 30 obtains an injection amount that reflects a larger value of both air-fuel ratio learned values as the largest value of the injection amount after λ correction. If the maximum value and the maximum value obtained in this way are both within the range of ±X % of the injection amount before λ correction, it is obvious that the injection amount after λ correction falls within the range regardless of the jet separation rate. Therefore, ECM 30 determines whether or not the condition (A) is successful based on whether or not both of the minimum value and the maximum value are within ±X % of the injection amount before λ correction.

Incidentally, a purge gas containing a large amount of fuel vapor may be introduced into the intake air, and a great reduction correction of the injection amount may be performed by the purge learning value reflected value. In such a case, even if the large amount increase correction of the injection amount is performed by the air-fuel ratio learned value, the discrepancy of the injection amount before and after the λ correction may not become too large. In such a case where the injection amounts are corrected so that the respective corrections cancel each other out, it may not be said that the variation in the injection amount is small only by the establishment of the above condition (A). Therefore, in the present embodiment, the condition (B) is set, and if the condition (B) is not satisfied even if the condition (A) is satisfied, it is determined that there is no small variation in the injection amount.

When ECM 30 determines that the variation of the injection amount is small (S120: YES, and S130: YES), the process proceeds to S140. Then, ECM 30 decides the injection pattern in S140 based on the injection amount before λ correction, that is, the request value of the amount of the fuel to be combusted in the combustion chamber 13. On the other hand, when ECM 30 determines that the variation of the injection amount is not small (S120: NO or $130: NO), the process proceeds to S150. In S150, ECM 30 decides the injection pattern based on the λ correction injection amount, that is, the final injection amount QFIN. The injection pattern represents the number of divisions of the fuel injection, the type and order of each injection.

ECM 30 proceeds to S160 after deciding the injection pattern at S140 or S150. In S160, ECM 30 decides an injection amount and a fuel injection timing of each injection of the decided injection pattern. Subsequently, ECM 30 commands the injectors 20 and 21 regarding the amount and the timing for the fuel injection decided by S160 in the subsequent S170, and then ends the process of this routine in the current control cycle.

### Deciding Injection Pattern

Next, the process of deciding the injection pattern in S140 and S150 of FIG. 2 will be described. When deciding the injection pattern, ECM 30 first refers to the selection table of the candidate list stored in the storage device 31, and selects the candidate list of the injection pattern based on the coolant temperature THW and the rotational speed NE of the internal combustion engine 10.

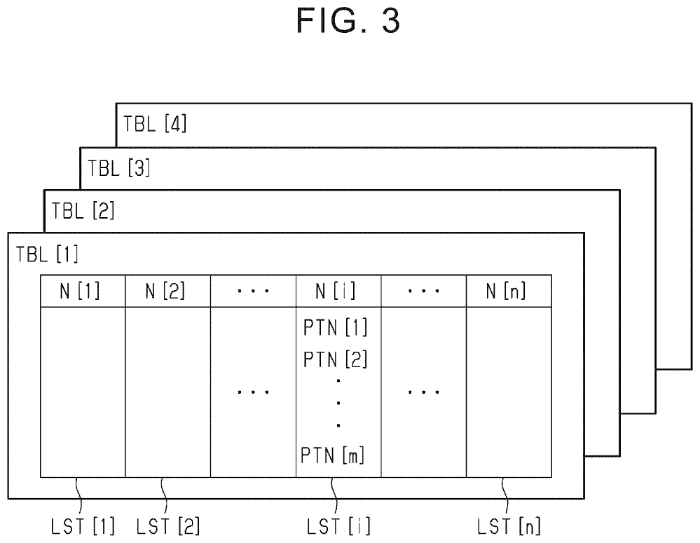

FIG. 3 illustrates an example of the setting mode of the selection table. In the present embodiment, TBL[4] is prepared from the individual selection table TBL[1] for each of the four water temperature ranges divided by the coolant temperature THW. The numbers of TBL[4] from the water temperature area and the selection table TBL[1] can be changed as appropriate.

From the respective selection tables TBL[1] to TBL[4], LST[n] are stored from the candidate-list LST[1] of the injection patterns corresponding to the respective n rotation speed ranges N[1] to N[n] divided by the rotational speed NE of the internal combustion engine 10. LST[1] to LST[n] are obtained by arranging a plurality of injection patterns in descending order of priorities. Here, an injection pattern having a high effect of suppressing adhesion of a wall surface of fuel is defined as an injection pattern having a high priority. Basically, in an injection pattern in which the number of divisions of fuel injection is large, the effect of suppressing the adhesion of the wall surface of the fuel is higher than in an injection pattern in which the number of divisions is small.

In the present embodiment, the types of fuel injection performed by PL multi-injection control are four types: port-injection, injection amount-fixed in-cylinder FL injection, injection amount-variable in-cylinder FL injection, and in-cylinder PL injection. The port injection is fuel injection into the intake port 19 by the port injection injector 20. The in-cylinder FL injection is fuel injection to the cylinder 11 by full-lift injection of the injector 21 for in-cylinder injection. The in-cylinder FL injection is further classified into an in-cylinder FL injection with a fixed injection amount and an in-cylinder FL injection with a variable injection amount capable of changing the injection amount. The in-cylinder PL injection is fuel injection to the cylinder 11 by partial lift injection of the injector 21 for in-cylinder injection. In the present embodiment, in PL multi-injection control, the in-cylinder PL injection is performed while the injection amount is fixed.

In the injection pattern in the candidate list, there are an injection pattern of only the port injection, an injection pattern of the ejection division including both the port injection and the in-cylinder injection, and an injection pattern of only the in-cylinder injection. All the in-cylinder FL jets included in the injection pattern of the jets are fixed injection amounts. That is, the in-cylinder injection in the injection pattern of the ejection division does not include the injection of the variable injection amount. Therefore, the total amount of the in-cylinder injection in the case where the port injection and the in-cylinder injection are separately performed is uniquely determined by the injection pattern.

Next, selection of the injection pattern from the candidate list will be described. In the following explanation, a candidate list corresponding to the present water temperature range and the present rotational velocity range N[i] is described as a candidate list LST[i]. Further, each of the “m” ejection patterns constituting the candidate list LST[i] is written as, in order from the head of the list, the ejection pattern PTN[1], the ejection pattern PTN[2], . . . , the injection pattern PTN[m].

First, the selection of the injection pattern in S150 of FIG. 2 when it is determined that the variation in the injection amount is not small will be described. ECM 30 selects an injection pattern from the candidate-list LST[i] based on the λ correction injection amount Q2. Specifically, ECM 30 selects, from the candidate list LST[i], an injection pattern that is located at the top of the list among injection patterns in which fuel injection of Q2 of the λ correction injection amounts can be executed, as an injection pattern to be executed.

ECM 30 determines whether or not fuel injection of Q2 of the λ correction injection amounts can be executed in the following manner. In each of the port-injection, the in-cylinder FL injection, and the in-cylinder PL injection, a lower limit injection amount is present. Therefore, for each injection pattern, there is a minimum injection amount QMIN which is a lower limit of the injection amount determined by the type of injection to be configured. ECM 30 determines that fuel injection of the injection amount Q2 after the λ correction can be executed by determining that the smallest injection amount QMIN of the injection pattern is smaller than the injection amount Q2 after the λ correction.

First, the selection of the injection pattern in S150 of FIG. 2 when it is determined that the variation in the injection amount is not small will be described. ECM 30 selects an injection pattern from the candidate-list LST [i] based on the λ correction injection amount Q2. Specifically, ECM 30 selects, from the candidate list LST [i], an injection pattern that is located at the top of the list among injection patterns in which fuel injection of Q2 of the λ correction injection amounts can be executed, as an injection pattern to be executed.

ECM 30 determines whether or not fuel injection of Q2 of the λ correction injection amounts can be executed in the following manner. In each of the port-injection, the in-cylinder FL injection, and the in-cylinder PL injection, a lower limit injection amount is present. Therefore, for each injection pattern, there is a minimum injection amount QMIN which is a lower limit of the injection amount determined by the type of injection to be configured. ECM 30 determines that fuel injection of the injection amount Q2 after the λ correction can be executed by determining that the smallest injection amount QMIN of the injection pattern is smaller than the injection amount Q2 after the λ correction.

Next, the selection of the injection pattern in S140 of FIG. 2 when it is determined that the variation in the injection amount is small will be described. ECM 30 selects an injection pattern from among the candidate-list LST[i] based on the injection amount Q1 before λ correction. Specifically, ECM 30 first calculates the determination injection amount QAST that is the relation of Expression (1) with respect to the injection amount Q1 before λ correction. Then, ECM 30 selects, from the candidate list LST[i], an injection pattern in which the smallest injection amount QMIN is located at the uppermost position in the list among the injection patterns smaller than the determination injection amount QAST as the injection pattern to be executed.

$$QAST = Q 1 \times ( 1 - X / 100 ) \qquad ( 1 )$$

The use of the above-described determination injection amount QAST for determining whether or not an injection pattern can be executed is based on the following reason. As described above, ECM 30 determines that the variation of the injection amount is small on the condition that the injection amount Q2 after the λ correction is within ±X % of the injection amount Q1 before the λ correction (S120: YES). Therefore, when the injection amount Q1 before λ correction is a particular value “Qx”, the range of values that can be taken by the injection amount Q2 after λ correction is a range from “Qx×(1−X/100” to “Qx×(1+X/100)”. The determination injection amount QAST represents the smallest value of the range of values that the λ correction injection amount Q2 can take.

### Operation of the Embodiment

ECM 30 serves as a fuel injection control device for the internal combustion engine 10. ECM 30 performs PL multi-injection control which is a split injection control in which fuel to be combusted in the combustion chamber 13 is injected into the injectors 20 and 21 in a plurality of times. In PL multi-injection control, the fuel injection pattern is switched in accordance with the operating state of the internal combustion engine 10. In PL multi-injection control, ECM 30 decides the injection pattern based on the coolant temperature THW, the rotational speed NE, and the injection amount of the internal combustion engine 10.

Generally, the operating range of the internal combustion engine 10 is defined by the rotational speed NE of the internal combustion engine 10 and the loading factor KL. Therefore, it is conceivable to decide the injection pattern by using the loading factor KL instead of the injection amount. On the other hand, when there is a range of injection amounts that can be performed for each injection pattern, and the total amount of fuel that needs to be injected is out of the range, the fuel injection in the injection pattern cannot be performed. Even if the loading factor KL is the same, the total amount of fuel injection required for injection may vary due to corrections or the like. Therefore, it is possible to accurately select an injection pattern that can be executed by using the injection amount rather than the loading factor KL.

On the other hand, ECM 30 performs λ correction that is correction based on the air-fuel ratio feedback correction value, the air-fuel ratio learned value, and the purge learning reflected value, and calculates a final injection amount QFIN that is a command value of the fuel injection amount of the injectors 20 and 21. The λ correction is a correction for compensating for a deviation between a request value of the amount of fuel to be combusted in the combustion chamber 13 and a command value of the fuel injection amount. Even if the command value of the fuel injection amount changes due to the λ correction, the amount of fuel actually burned does not change. Therefore, even under the same operating conditions, different values may be set as the command value of the fuel injection amount. Therefore, when the injection pattern is decided based on the command value of the fuel injection amount, there is a possibility that a different injection pattern is selected even under the same operating condition due to the variation of the injection amount. On the other hand, in ECM 30 of the present embodiment, when the variation in the injection amount is small, the injection pattern is decided based on the injection amount Q1 before the λ correction. Therefore, an accurate injection pattern corresponding to the operating state of the internal combustion engine 10 is selected regardless of the variation in the injection amount.

If the correction rate of the λ correction becomes larger than a certain amount, fuel injection at the injection pattern decided based on the injection amount Q1 before the λ correction may not be able to be executed. In contrast, ECM 30 decides the injection pattern based on the λ correction injection amount Q2 when the variation in the injection amount is not small. Therefore, even when the discrepancy of the injection amount Q1, Q2 before and after the λ correction is large, an executable injection pattern is selected.

### Effect of the Embodiment

The fuel injection control device of the present embodiment has the following effects.
(1) ECM 30 calculates the injection amount Q1, Q2 before and after the A-correction in PL multi-injection control. The injection amount Q1 before the A correction corresponds to the request amount of the fuel to be combusted in the combustion chamber 13. The λ correction injection amount Q2 corresponds to a command value of the fuel injection amount of the injectors 20 and 21. ECM 30 calculates the value of the injection amount Q2 after the λ correction by providing the λ correction for compensating for the deviation between the injection amount Q1 before the λ correction and the amount of the actually burned fuel to the injection amount Q1 before the λ correction. Further, in PL multi-injection control, ECM 30 determines whether or not the discrepancy of the injection amount Q1, Q2 before and after the λ-correction is small. Then, ECM 30 decides the injection patterns based on the injection amount Q1 before λ correction when it is determined that the discrepancy is in a small state, and based on the injection amount Q2 after λ correction when it is determined that the discrepancy is not in a small state. The fuel injection control device of the present embodiment has an effect of enabling setting of an appropriate injection pattern in accordance with an operating state of the internal combustion engine 10.
(2) When it is determined that the discrepancy is not small, ECM 30 selects a pattern in which the number of divisions of the fuel injection is maximized in the injection pattern in which the fuel injection of the λ correction injection amount Q2 can be executed. The larger the number of divisions, the smaller the injection amount per injection, and the lower the adhesion of the wall surface of the fuel. Therefore, even in a state in which the variation in the injection amount is large, adhesion of the wall surface of the fuel can be effectively suppressed.
(3) ECM 30 determines whether or not the discrepancy is small based on the injection amount Q1, Q2 before and after the λ correction and the air-fuel ratio learned value KGP, KGD. When the corrections of the λ correction cancel each other out, the discrepancy of the injection amount Q1, Q2 before and after the λ correction may not be so large even when the variation of the injection amount is large. Even in such cases, accurate determination can be made by looking at the air-fuel ratio learned values KGP, KGD. Other Embodiments

The present embodiment can be modified and implemented as follows. The present embodiment and modification examples described below may be carried out in combination of each other within a technically consistent range.
As a correction for compensating for a deviation between an amount of fuel actually burned and a request value of an amount of fuel to be burned, a correction other than those described above may be performed.
PL multi-injection control may be appropriately performed.
The selection logic of the injection pattern in the above-described embodiment can also be applied to other split injection control such as split injection control that does not include PL injection.
The determination process of S110 in FIG. 2 may be omitted, and it may be determined that the variation in the injection amount is small only by the affirmative determination in S100. That is, the determination may be made based only on the injection amount Q1, Q2 before and after the λ correction without checking the value of the air-fuel ratio learned value KGP, KGD itself.
In the above-described embodiment, the candidate-list LST[i] of the current rotational velocity range is acquired from TBL[4] from the selection table TBL[1] corresponding to the current water temperature range. Then, the injection pattern of the split injection is decided by selecting the injection pattern based on the candidate-list LST[i] based on the injection amount Q1, Q2 before or after the λ correction. The specific methods for deciding the injection patterns may be appropriately changed as long as they are based on the injection amount Q1, Q2 before or after the λ correction.
In the above-described embodiment, the injection pattern of the split injection is decided based on the coolant temperature THW, the rotational speed NE, and the injection amount Q1, Q2 before or after the λ correction of the internal combustion engine 10. The injection pattern may be decided based only on the injection amount Q1, Q2 before λ. correction or after λ correction without using one or both of the coolant temperature THW and the rotational speed NE.

What is claimed is:

1. A fuel injection control device that performs split injection control, the fuel injection control device performing,
in the split injection control,
computing a request value for an amount of fuel to be combusted in a combustion chamber,
deciding a command value for a fuel injection amount by applying a correction, for compensating for a deviation between an amount of fuel that is actually combusted and the request value, to the request value,
determining whether discrepancy between the request value and the command value is in a small state, and
deciding an injection pattern of split injection based on the request value when determining that the discrepancy is in a small state, while deciding the injection pattern based on the command value when determining that the discrepancy is not in a small state.

2. The fuel injection control device according to claim 1, wherein, when determination is made that the discrepancy is not in a small state, a pattern in which a count of injections into which fuel injection is divided is greatest, is selected from among the injection patterns by which the fuel injection of the amount indicated by the command value is executable.

3. The fuel injection control device according to claim 1, wherein the correction for compensating for the deviation includes one or more of correction by an air-fuel ratio feedback correction value, correction by an air-fuel ratio learned value, and correction by a purge learning reflected value.

4. The fuel injection control device according to claim 1, wherein
a plurality of the correction, including correction by an air-fuel ratio learned value, is present in the correction for compensating for the deviation, and
determination is made regarding whether the discrepancy is small, based on the request value, the command value, and the air-fuel ratio learned value.

5. The fuel injection control device according to claim 1, wherein an injection pattern including partial lift injection is included in the injection patterns that are carried out by the split injection control.
